(19) United States
(12) Patent Application Publication
(10) Pub. No.: US 2005/0082331 A1
(43) Pub. Date: Apr. 21, 2005

(54) Tempered glass breaker

(76) Inventor: Chi-Hong Yang, Changhua City (TW)

Correspondence Address: RABIN & BERDO, P.C., Suite 500, 1101 14th Street, N.W., Washington, DC, 20005, US

(21) Appl. No.: 10/686,735

(22) Filed: Oct. 17, 2003

(51) Int. Cl. C03B 33/03; B26F 3/00; B26F 1/31

(52) U.S. Cl. 225/2; 225/94; 30/361; 30/358; 30/366

(57) ABSTRACT

A tempered glass breaker comprised of a main member, a spring, a drift pin, and a mounting base. The main member is positioned at the upper extent of the mounting base, the main member is sleeved into the spring, and the drift pin is situated at the lower extent. When a critical situation occurs, the application of external force enables the drift pin at the front extremity of the main member to directly impact a lateral corner of the tempered glass and cause the breakage of the glass to assist emergency escape. Moreover, the breaker structure of the present invention is simple, economical, and practical.

### BACKGROUND OF THE INVENTION

1) Field of the Invention

The invention herein relates to plate glass accessories and hardware, specifically a tempered glass breaker that provides for utilization in vehicles (buses, trucks, and trains) or buildings for shattering tempered glass during emergency situations where escape is vital for the protection of life and property.

2) Description of the Prior Art

Conventional structures include the following Taiwan Patents: No. 499960, No. 363426, No. 353951, No. 309769, No. 302698, No. 284081, No. 278393, and No. 267351. However, the conventional typically utilizes a stored or portable breaking tool located in a vehicle that is taken out when a situation arises or carried in preparation for one, the use of such products resulting in various inconveniences and, furthermore, their structural design tends to be overly complex and beset by other problems.

In view of this, the applicant of the invention herein conducted research and development on tempered glass breaker structures utilized in vehicles and buildings to innovate a product that is more practical to manufacture as well as original and progressive, which culminated in the successful development of the structure of the present invention.

### SUMMARY OF THE INVENTION

The primary objective of the invention herein is to provide a tempered glass breaker in which the drift pin at the lower extent of the main member directly impacts the lateral corner of the tempered glass and causes the breakage of the glass to assist emergency escape and, furthermore, which has a structure that is simple, economical, and practical.

To further introduce the structural components and embodiments of the present invention, the brief description of the drawings below are followed by the detailed description of the invention herein.

### BRIEF DESCRIPTION OF THE DRAWINGS

FIG. 1 is an isometric drawing of the invention herein.

FIG. 2 is an exploded drawing of the invention herein.

FIG. 3 is a cross-sectional drawing of the invention herein.

FIG. 4 is a cross-sectional drawing of the invention herein, as viewed from the perspective of line 4-4.

FIG. 5 is a cross-sectional drawing of the invention herein, with the drift pin adjusted to the retracted state.

FIG. 6 is a cross-sectional drawing of the invention herein, with the drift pin adjusted to the extended state.

FIG. 7 is a cross-sectional drawing of the invention here as outward force causes the breakage of the tempered glass.

FIG. 8 is a cross-sectional drawing of the invention herein that illustrates the striking of the tempered glass after the outward force is released.

FIG. 9 is magnified drawing of the invention herein as installed in the corner area of a vehicle window.

FIG. 10 is an orthographic drawing of the invention herein installed in the corner area of a vehicle window.

FIG. 11 is an isometric drawing of another embodiment of the invention herein.

FIG. 12 is an exploded drawing of the other embodiment of the invention herein.

FIG. 13 is a cross-sectional drawing of the other embodiment of the invention herein, with the drift pin adjusted to the retracted state.

FIG. 14 is a cross-sectional drawing of the other embodiment of the invention herein, with the drift pin adjusted to the extended state.

FIG. 15 is a cross-sectional drawing of the other embodiment of the invention here as outward force causes the breakage of the tempered glass.

FIG. 16 is a cross-sectional drawing of the other embodiment of the invention herein that illustrates the striking of the tempered glass after the outward force released.

FIG. 17 is magnified drawing of the other embodiment of the invention herein as installed in the corner area of a vehicle window.

FIG. 18 is an orthographic drawing of the other embodiment of the invention herein installed in the corner area of a vehicle window.

FIG. 19 is a cross-sectional drawing of the drift pin of the invention herein, with the conical tip shaped as an acute point.

FIG. 20 is a cross-sectional drawing of the drift pin of the invention herein, with the conical tip in shaped as an obtuse point.

### DETAILED DESCRIPTION OF THE INVENTION

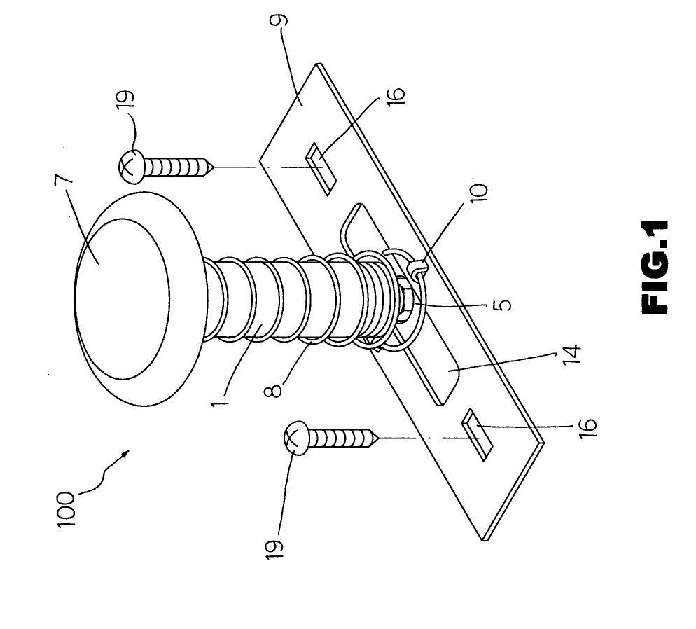

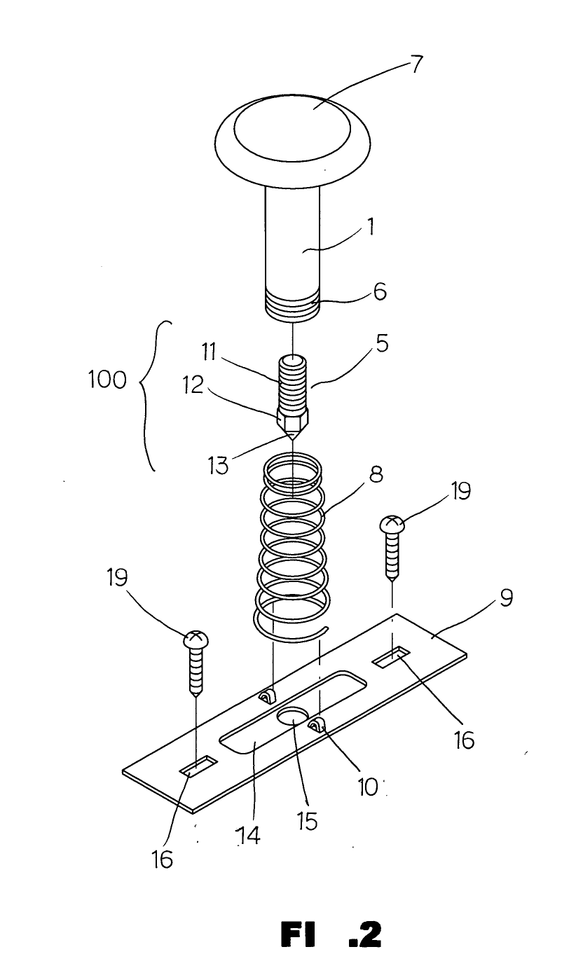

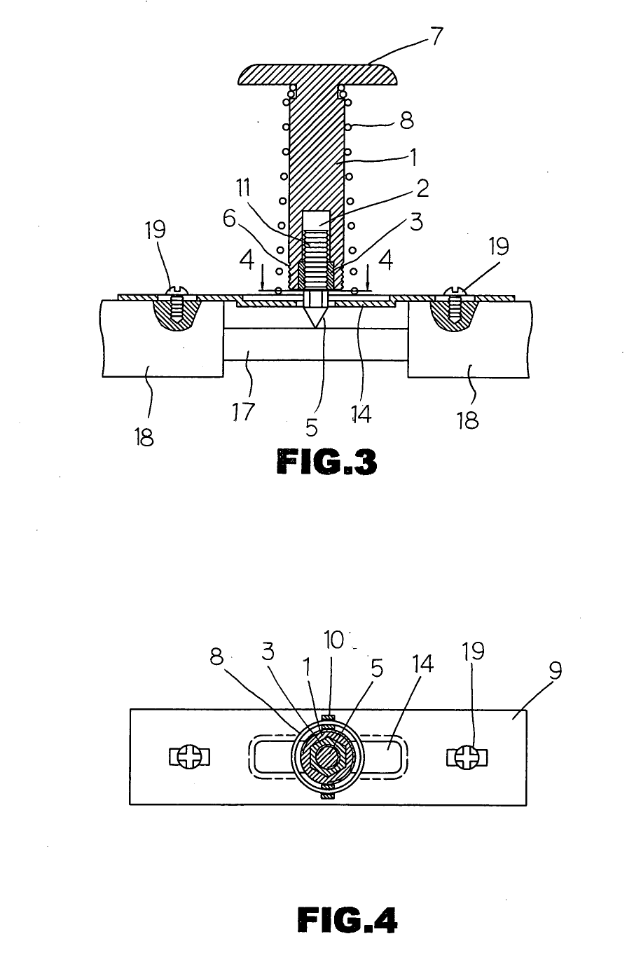

Referring to FIG. 1, FIG. 2, FIG. 3, and FIG. 4, the tempered glass breaker 100 of the invention herein is comprised of:

A main member 1 having a passage 2 formed in its lower extent, with a nut 3 embedded in the passage 2 that enables the fastening of a drift pin 5 into the nut 3 and its situating at the lower extent; the main member 1 has external threads 6 died around its lower extent and a striking surface 7 of larger square area disposed at its upper extent.

A spring 8 sleeved onto the exterior of the main member 1, the bottom end of the spring 8 fixed to spring anchoring hooks 10 on a mounting base 9.

A drift pin 5, the drift pin 5 having external threads 11 along the posterior section, hexagonal facets 12 at the center section, and a cone 13 at the anterior section and, furthermore, with the tip of the cone 13 shaped as an acute point or an obtuse point.

A mounting base 9, the said mounting base 9 has an indented reinforcement trough 14 along the middle, a hole 15 disposed at the center of the reinforcement trough 14 that is aligned with the drift pin 5, spring anchoring hooks 10 near the two sides of the hole 15, and an adjustment hole 16 at each of the two sides of the reinforcement trough 14.

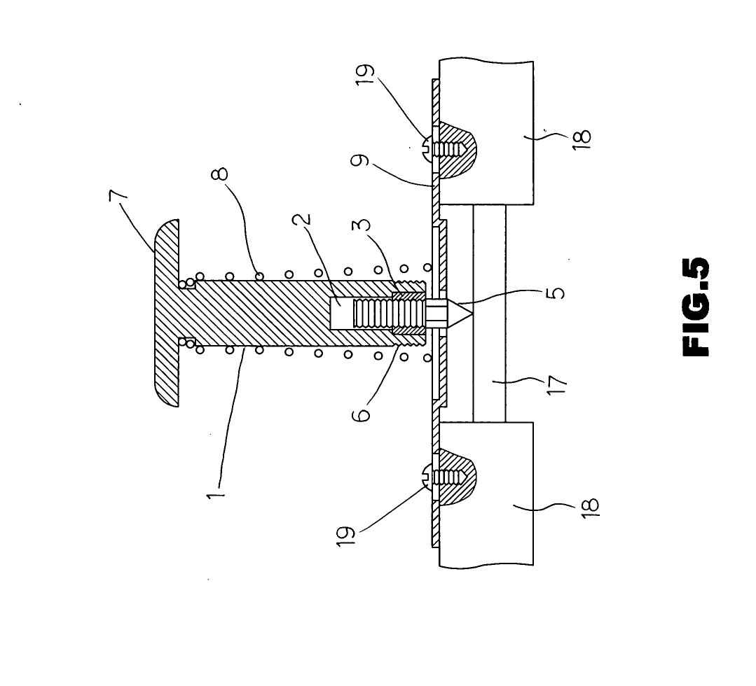

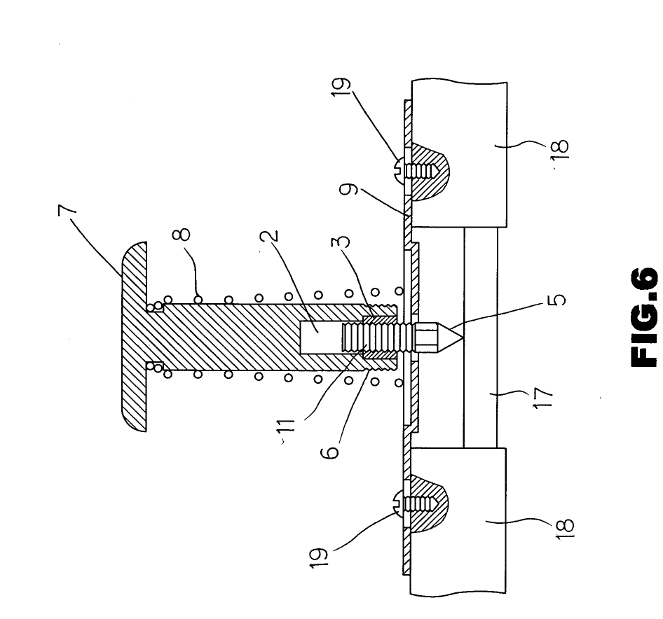

Referring to FIG. 5 and FIG. 6, after the said structural components are assembled together, the said breaker 100 drift pin 5 is first manually rotated via the hexagonal facets 12 such that the drift pin 5 retracts (as shown in FIG. 5) or extends (as shown in FIG. 6), the initial adjustment maintaining an appropriate distance between the drift pin 5 and the glass 17, with the drift pin 5 kept in position by the application to the drift pin 5 of an adhesive substance.

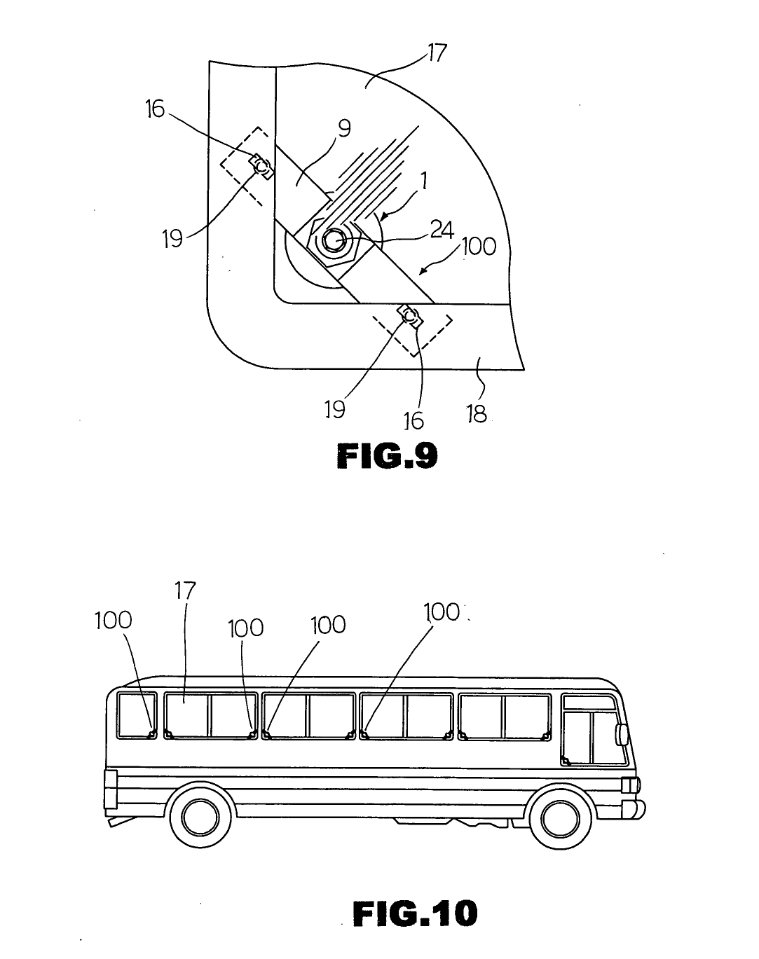

Referring to FIG. 9 and FIG. 10, the said tempered glass breaker 100 mounting base 9 is slanted approximately 45 degrees to match the window frame 18 angle, and then fastened onto the window frame 18 by means of screws 19 via the mounting base 9 adjustment holes 16, which completes the installation procedure.

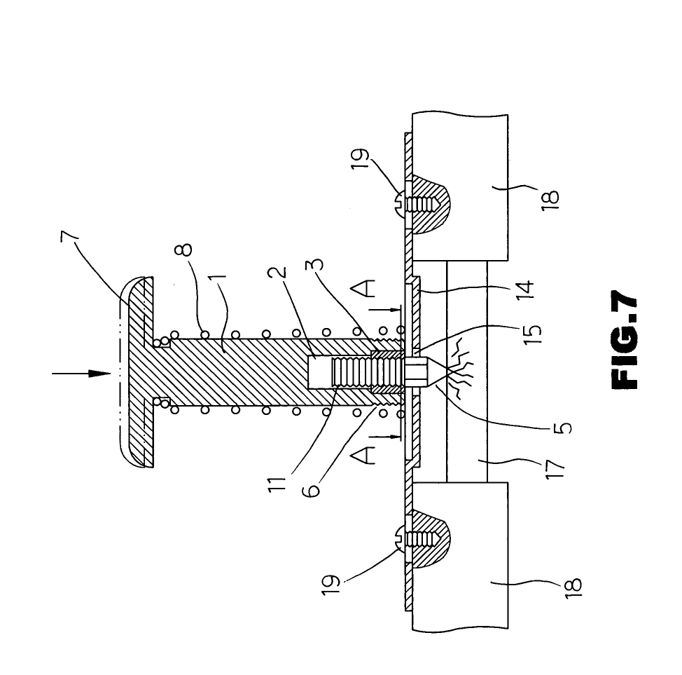

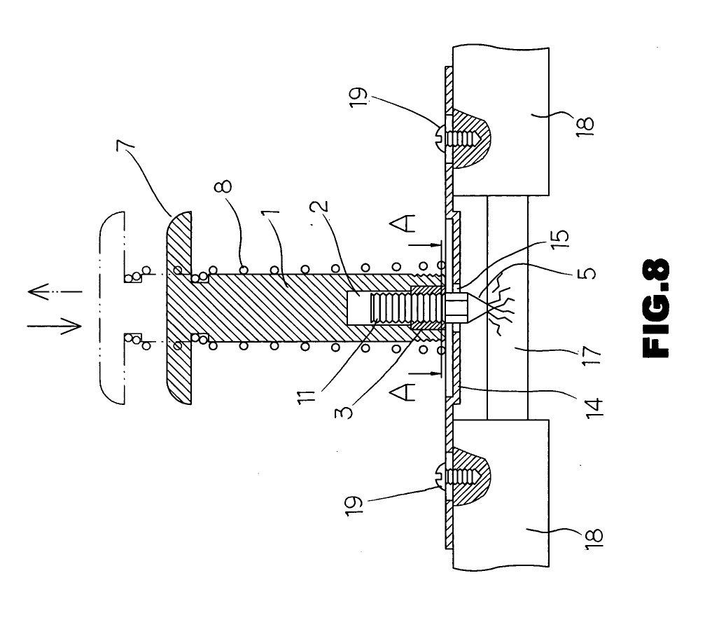

Referring to FIG. 7 and FIG. 8, during a critical situation, the user manually delivers a strong external force to the striking surface 7, as indicated in FIG. 7, or uses the feet to kick the striking surface 7; as indicated in FIG. 8, the striking surface 7 of the main member 1 can also be pulled and then released, the rebound force of the spring 8 impelling the drift pin 5 forward; when the main member 1 striking surface 7 is subjected to a powerful external force, the drift pin 5 situated at its lower extent is driven forward against the glass 17, impacting the weakest point at the lateral corner of the tempered glass 17 and causing breakage, assisting persons to escape entrapment during emergencies and thereby safely protect life and property.

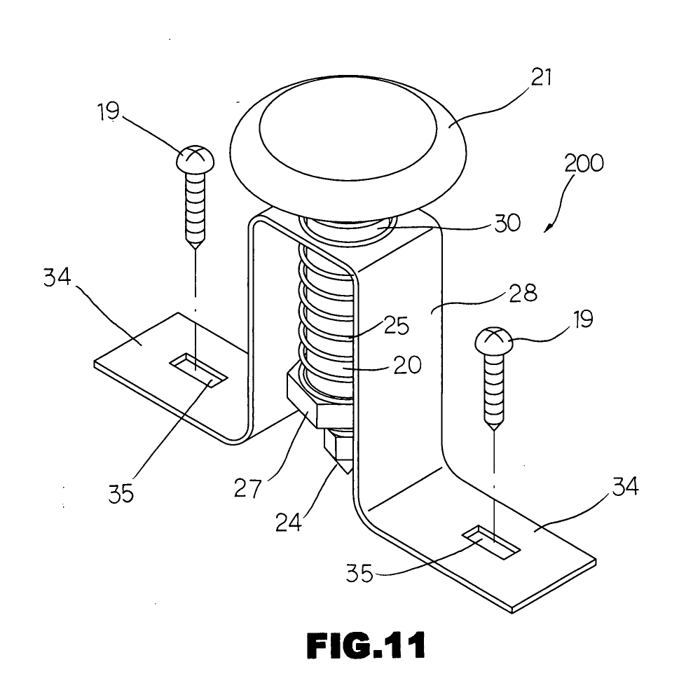

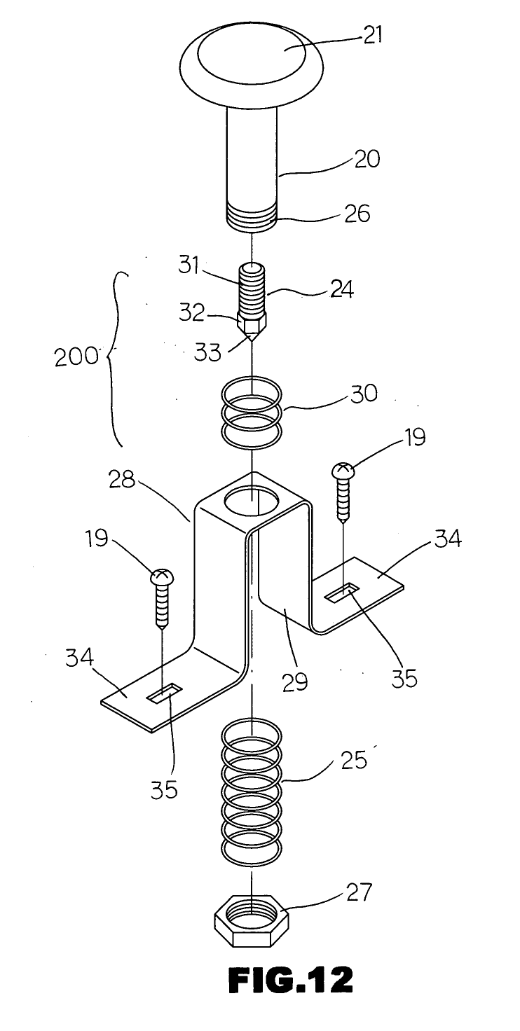

Additionally, the invention herein supports another embodiment, the other embodiment (B), referring to FIG. 11 and FIG. 12, comprised of:

A main member 20, the main member 20 having a striking surface 21 of larger square area disposed at its upper extent and a passage 2 formed in its lower extent; a nut 3 is embedded in the passage 2, with a drift pin 5 fastened into the nut 3 and positioned at the lower extent of the main member 20; the main member 20 is sleeved into the spring 25, external threads 26 are died around its lower extent, and a nut 27 is fastened thereon; and the anterior section of the main body 20 is situated in a U-shaped bend 29 of the mounting base 28.

Two springs: a short spring 30 situated between the striking surface 21 and the mounting base 28 and long spring 25 positioned in the mounting base 28 U-shaped bend 29.

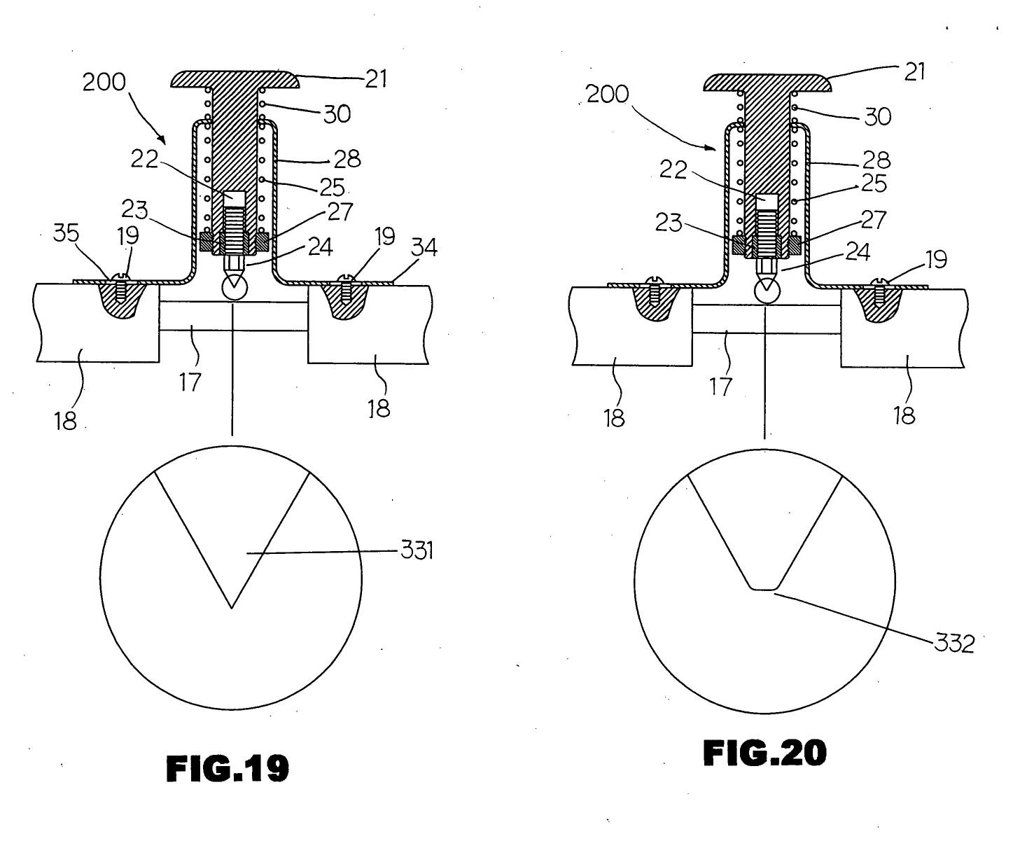

A drift pin 24 having external threads 31 along the posterior section, hexagonal facets 32 at the center section, and a cone 33 at the anterior section and, furthermore, with the tip of the cone 33 shaped as an acute point 331 or an obtuse point 332 (as shown in FIG. 19 and FIG. 20).

A mounting base 28 consisting of a U-shaped bend 29, a hole 36 through the bend 29, a tab 34 extending from each of its two sides, and an adjustment hole 35 formed in each of the tabs 34.

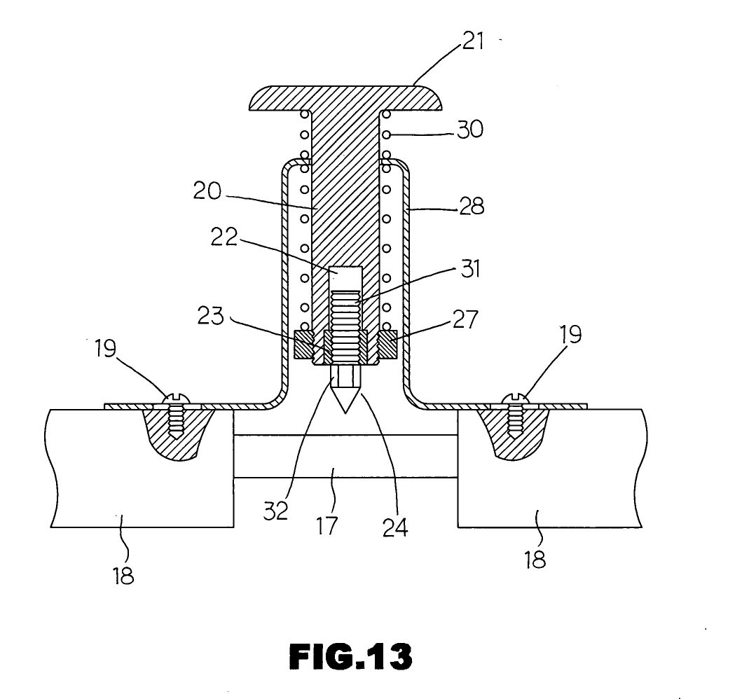

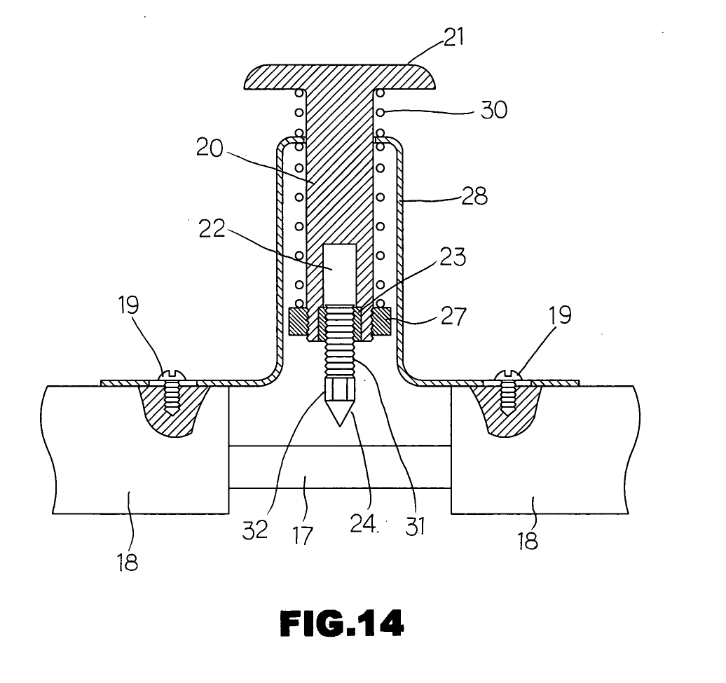

Referring to FIG. 13 and FIG. 14, after the said structural components are assembled together, the length of the said breaker 200 drift pin 24 is first adjusted as part of installation procedure, wherein the hexagonal facets 32 are manually rotated such that the drift pin 24 retracts (as shown in FIG. 13) or extends (as shown in FIG. 14), the initial adjustment maintaining an appropriate distance between the drift pin 24 and the glass 17, with the drift pin 24 kept in position by the application to the drift pin 24 of an adhesive substance.

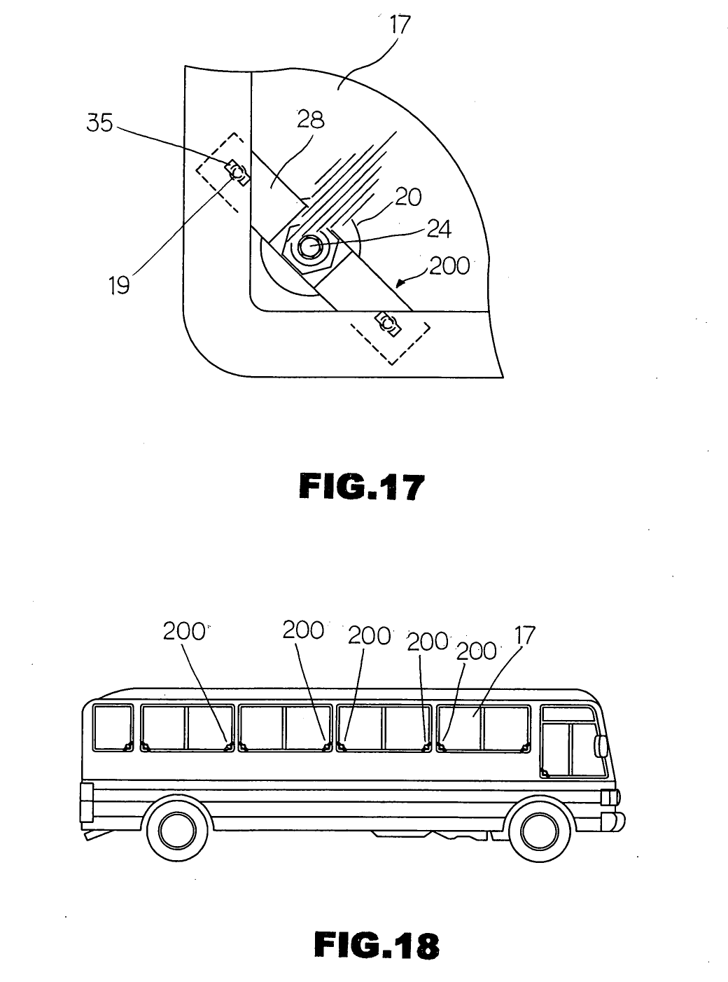

Following which, referring to FIG. 17 and FIG. 18, the said tempered glass breaker 200 mounting base 28 is slanted approximately 45 degrees to match the window frame 18 angle, and then fastened onto the window frame 18 by means of screws 19 via the mounting base 28 adjustment holes 35, which completes the installation procedure.

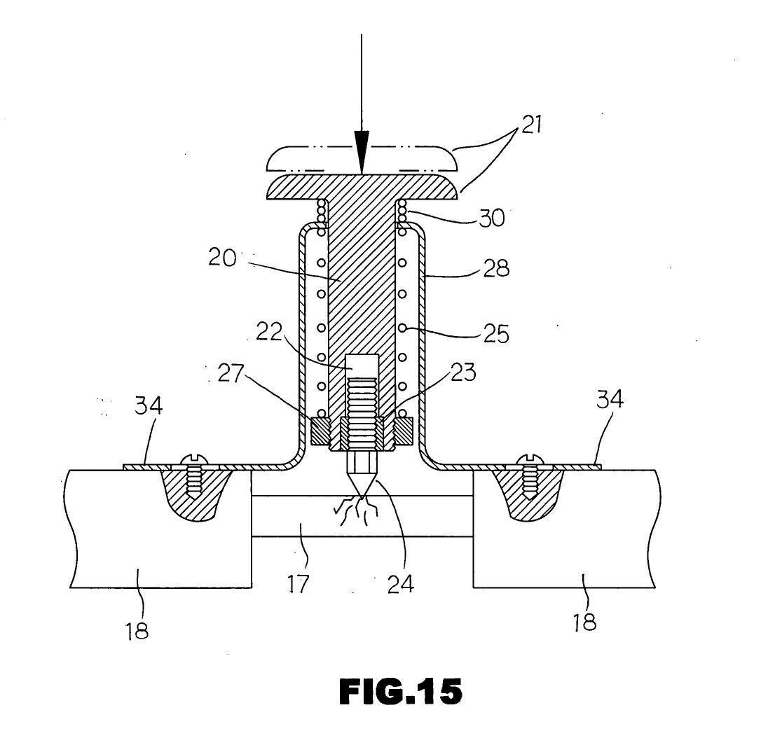

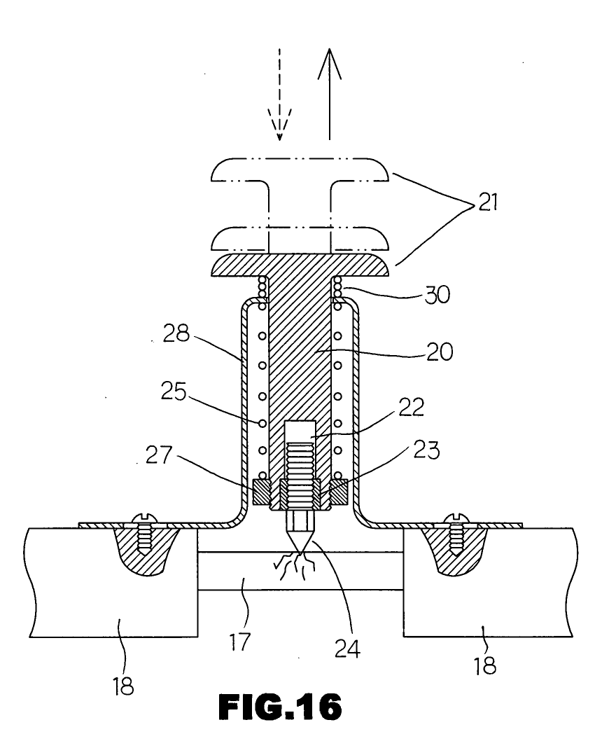

Referring to FIG. 15 and FIG. 16, during a critical situation, the user manually delivers a strong external force to the striking surface 21, as indicated in FIG. 15, or uses the feet to kick the striking surface 21; the striking surface 21 of the main member 20 can also be pulled and then released, as indicated in FIG. 16; when the main member 20 striking surface 21 is subjected to a powerful external force, the drift pin 24 situated at its lower extent is driven forward against the glass 17, impacting the weakest point at the lateral corner of the tempered glass 17 and causing breakage, assisting persons to escape entrapment during emergencies and thereby safely protect life and property.

The invention herein has the following advantages:
1. During critical situations, forcibly kicking the sole of the feet against the striking surface causes the internally hidden drift pin to compress the spring, the direct impact of which breaks the tempered glass to facilitate escape.
2. No batteries or external power supply is required.
3. No special safeguards, maintenance, or precautions.

In summation of the foregoing section, the invention herein is original and progressive and, furthermore, the said detailed description only discloses the most preferred embodiment of the present invention and shall not be construed as a limitation on the scope of the invention herein. Additionally, all modifications and embellishments based on the submitted patent application shall remain protected under the patent claims of the invention herein.

1. A tempered glass breaker comprised of a main member, a spring, a drift pin, and a mounting base; the said main member has a passage formed in its lower extent, with a nut embedded in the said passage that enables the fastening of a drift pin into the said nut and its situating at the lower extent; the said spring is sleeved onto the exterior of the said main member, the bottom end of the said spring fixed to spring anchoring hooks on the said mounting base; the said mounting base has an indented reinforcement trough along the middle, a hole disposed at the center of the said reinforcement trough that is aligned with the said drift pin, and an adjustment hole at each of the two sides of the said reinforcement trough that provide for fastening the said mounting base at a slant onto a window frame by means of screws.

2. As mentioned in claim 1 of the tempered glass breaker invention herein, the said mounting base is U-shaped and has a hole through its upper extent, a tab extending from each of its two sides, and an adjustment hole formed in each of the said tabs that provides for fastening the said mounting base onto the said window frame by means of the said screws.

3. As mentioned in claim 1 of the tempered glass breaker invention herein, the said main member is sleeved into a spring, external threads are died around its lower extent, and a nut is fastened thereon; and the anterior section of the said main body is situated in a U-shaped bend of the said mounting base; a short spring is situated between the upper edge of the said mounting base and the striking surface of the said main member, a tab extends from each of the two sides of the said mounting base U-shaped bend, and an adjustment hole is formed in each of the said tabs to provide for fastening to the said window frame by means of the said screws.

4. As mentioned in claim 1 of the tempered glass breaker invention herein, the said drift pin has external threads along the posterior section, hexagonal facets at the center section, and a cone at the anterior section.

5. As mentioned in claim 1 of the tempered glass breaker invention herein, the said drift pin cone has a tip that is shaped as an acute point or an obtuse point.

6. As mentioned in claim 1 of the tempered glass breaker invention herein, the said mounting base is U-shaped and has a hole through its upper extent, a tab extending from each of its two sides, and an adjustment hole formed in each of the said tabs that provides for fastening the said mounting base onto the said window frame by means of the said screws.

7. As mentioned in claim 1 of the tempered glass breaker invention herein, the said tempered glass breaker mounting base is slanted approximately 45 degrees to match the angle of the said window frame, and then fastened onto the said window frame by means of the said screws via the said mounting base adjustment holes.
